(19) United States
(12) Patent Application Publication
(10) Pub. No.: US 2014/0214402 A1
(43) Pub. Date: Jul. 31, 2014

(54) IMPLEMENTATION OF UNSUPERVISED TOPIC SEGMENTATION IN A DATA COMMUNICATIONS ENVIRONMENT

(71) Applicants: Qian Diao, San Jose, CA (US); Venkata Ramana Rao Gadde, Santa Clara, CA (US)

(72) Inventors: Qian Diao, San Jose, CA (US); Venkata Ramana Rao Gadde, Santa Clara, CA (US)

(73) Assignee: CISCO TECHNOLOGY, INC., San Jose, CA (US)

(21) Appl. No.: 13/750,049

(22) Filed: Jan. 25, 2013

(51) Int. Cl. G06F 17/21

(52) U.S. Cl. CPC G06F 17/21
USPC 704/9

(57) ABSTRACT

A method is provided in one example embodiment and includes extracting sentences from data, which comprises a speech transcript; tokenizing the plurality of sentences to develop for each of the plurality of sentences a sentence vector and at least one feature vector; and performing topic segmentation on the speech transcript using the sentence vectors and feature vectors, the topic segmentation resulting in a listing of segments corresponding to the speech transcript. In certain embodiments, the feature vector may be at least one of a cue word feature vector, a speaker change feature vector, and a scene change feature vector.

### TECHNICAL FIELD

This disclosure relates generally to topic segmentation techniques and, more particularly, to techniques for implementing unsupervised topic segmentation in a data communications environment.

### BACKGROUND

The task of topic segmentation concerns the detection of a topic boundary in a stream of text or speech data. More particularly, topic segmentation is the division of language data into segments based on the topic or subject being discussed. For example, a news broadcast that presents three different stories divides quite naturally into three separate topics. Less obviously, a magazine article, which may ostensibly cover a single main topic, will usually include several sub-topics comprising different aspects of the main topic. Topic segmentation is useful in connection with a variety of text mining applications, such as document retrieval, text summarization, and question answering, to name a few. Bayesian unsupervised topic segmentation (“BayesSeg”) is a state-of-the-art method for performing topic segmentation.

BayesSeg assumes that cue words are unknown, so a method should consider every first word of the sentence at the segment boundary and create a special language model to incorporate all of those words into the generative model. Because the counts for the specific language model are summed across all segments in the database, rather than just the lexical counts for a particular segment and for the segment boundaries, shifting a boundary will affect the probability of all segments and not just the adjacent segments. As a result, the original factorization that enables dynamic programming inference is not applicable. Instead, an approximate inference, for example, a sampling-based inference, such as Monte Carlo Expectation-Maximization (“MCEM”), should be used.

In some instances, the cue word list (or other potential boundary indicator/feature, such as speaker change or scene change information) could be known in advance. This is especially true when some there is some knowledge of the data domain the application. For example, assuming the task is to perform topic segmentation on enterprise videos comprising all-hands meeting videos or some structural meeting videos, the cue words used by speakers will generally be found to be quite consistent. In such a scenario, having a generative model that incorporated such additional features would be useful in accomplishing the topic segmentation task.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system for implementing an unsupervised topic segmentation method in a communications environment in accordance with one embodiment;

FIG. 2 is a more detailed block diagram of a system for implementing an unsupervised topic segmentation method in a communications environment in accordance with one embodiment;

FIG. 3 illustrates a topic listing that may be generated by a system for implementing an unsupervised topic segmentation method in a communications environment in accordance with one embodiment;

FIG. 4 is a flowchart illustrating a method for performing unsupervised topic segmentation in a communications environment in accordance with one embodiment; and

FIG. 5 is a flowchart illustrating in greater detail an aspect of a method for performing unsupervised topic segmentation in a communications environment in accordance with one embodiment.

### DETAILED DESCRIPTION OF EXAMPLE EMBODIMENTS

### Overview

A method is provided in one example embodiment and includes extracting (e.g., identifying, evaluating, copying, cutting, removing, processing, etc.) a plurality of sentences from data, which comprises a speech transcript. The speech transcript may be part of any file, database, repository, record, etc. The method also includes tokenizing (e.g., breaking-up, segmenting, logically categorizing, processing, etc. data into one or more tokens) the plurality of sentences to develop (for each of the plurality of sentences) a sentence vector and at least one feature vector. The term ‘vector’ in this context can include any type of tag, attribute, token, label, identifier, etc. The method also includes performing topic segmentation on the speech transcript using the sentence vectors and feature vectors, the topic segmentation resulting in a listing of segments corresponding to the speech transcript. The method may further include preprocessing source data generated by a data source to develop the speech transcript. In one embodiment, the source data may be audio data; in another embodiment, the source data may include both audio data and video data. In certain embodiments, the listing of segments comprises an index to the source data. The method may further include performing post-processing on the listing of segments to remove from the listing items that do not meet minimum requirements for segments. The method may still further include performing post-processing on the listing of segments to assign a title to each segment in the listing based on key words in the segment. In certain embodiments, the feature vector may be at least one of a cue word feature vector, a speaker change feature vector, and a scene change feature vector. Topic segmentation may be performed using segmentation boundary searching by dynamic programming.

### Example Embodiments

As will be described in greater detail below, in one embodiment, an approach is presented for incorporating additional features, such as cue words, speaker change information, scene change information, or any other human expert knowledge and early estimation results from other topic segmentation systems, into the Bayesian unsupervised topic segmentation (“BayesSeg”) method. Feature functions are defined to quantify those features and then they are added as the “segmentation prior” into the generative Bayesian framework. In this manner, a principled method is provided to combine multiple cues for the unsupervised topic segmentation task.

In general, unsupervised systems for performing topic segmentation are driven by lexical cohesion, which is the tendency of well-formed segments to induce a compact and consistent lexical distribution. BayesSeg places the lexical cohesion in a Bayesian context by modeling the words in each topic segment as draws from a multinomial language model associated with the segment. Maximization of the observation likelihood in the model results in a lexically cohesive segmentation. While lexical cohesion is an effective driver for unsupervised topic segmentation systems, other important potential boundary indicators include cue words comprising discourse markers such as “therefore” and “now,” for example.

Bayesian inference is a method of inference in which Bayes' rule is used to update the probability estimate for a hypothesis as additional evidence is procured. Bayesian inference is an important technique in many areas of statistics; exhibiting a Bayesian derivation for a statistical model automatically ensures that the method works as well as any competing method, for some cases. Bayesian updating is especially important in the dynamic analysis of a sequence of data.

In general, Bayesian analysis is a statistical procedure for estimating parameters of an underlying distribution based on an observed distribution. Analysis begins with a “prior distribution” or “prior,” which may be based on any number of observations, including an assessment of the relative likelihoods of parameters or the results of non-Bayesian observations. A uniform distribution over the appropriate range of values for the prior distribution is commonly assumed. Given the prior distribution, data is collected to obtain the observed distortion and the likelihood of the observed distribution is calculated as a function of parameter values. The likelihood function is multiplied by the prior distribution and the result is normalized to obtain a unit probability (referred to as the “posterior distribution”) over all possible values. The mode of the distribution is the parameter estimate and probability intervals can be calculated using standard procedures.

The following discussion references various embodiments. However, it should be understood that the disclosure is not limited to specifically described embodiments. Instead, any combination of the following features and elements, whether related to different embodiments or not, is contemplated to implement and practice the disclosure. Furthermore, although embodiments may achieve advantages over other possible solutions and/or over existing systems, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any subject matter disclosed herein and shall not be considered to be an element or limitation of the appended claims except where explicitly recited in a claim(s).

As will be appreciated, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, aspects of the present disclosure may take the form of a computer program product embodied in one or more non-transitory computer readable medium(s) having computer readable program code encoded thereon.

Any combination of one or more non-transitory computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

Computer program code for carrying out operations for aspects of the present disclosure may be written in any combination of one or more programming languages, including an object oriented programming language such as Java™, Smalltalk™, C++ or the like and conventional procedural programming languages, such as the “C” programming language or similar programming languages.

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a different order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The unsupervised topic segmentation technique known as the BayesSeg method places lexical cohesion in a probabilistic context by modeling the words in each topic segment as draws from a multinomial language model associated with the segment. As described in Eisenstein & Barzilay, Bayesian Unsupervised Topic Segmentation, Proceedings of the 2008 Conference on Empirical Methods in Natural Language Processing (2008) pages 334-343 (which is hereby incorporated by reference in its entirety) BayesSeg takes advantage of the

Bayesian framework to provide a way in which to incorporate additional features or “boundary indicators,” such as cue words.

In particular, if sentence t is in segment j, then the collection of words xₜ is drawn from the multinomial language model θₜ. In this method, the topics are constrained to yield a linear segmentation of the text. Additionally, it is assumed that topic breaks occur at sentence boundaries, which are fairly easily detectable due to punctuation and other conventions of a given language model, and zₜ is written to indicate the topic assignment for sentence t. The observation likelihood may be expressed as:

$$p ( X \vert z , θ ) = {{\prod }_{i}}^{T} p ( {x}_{i} \vert {θ}_{{z}_{t}} )$$

where X is the set of all T sentences, z is the segment index and comprises the vector of segment assignments for each sentence, and θ is the set of all K language models. A linear segmentation is ensured by the constraint that zₜ should be equal to either zₜ₋₁ (the previous sentence's segment) or zₜ₋₁+1 (the next segment).

In the BayesSeg method, the optimal segmentation maximizes the joint probability in accordance with Equation 1 below:

p(X, z|θ)=p(X|z, θ) p(z) (1)

In the BayesSeg method, p(z) is assumed to be a uniform distribution over valid segmentations and no probability mass is assigned to invalid segmentations. The objective function can be decomposed into a product across segments, so the BayesSeg method employs dynamic programming to make inferences. The objective function for the optimal segmentation up to sentence t is then given by the recursive relation set forth in Equation 2 below:

B(t)=max_{t′<t}(B(t′)b(t′+1, t))=max_{t′<t} (B(t′){p [x_{t′+1}, . . . xₜ}|z_{t′+1, . . . t}=j)) (2)

where the base case B(0)=1.

In certain embodiments described herein, to incorporate the cue words, speaker change, scene change, and/or other potential boundary indicator information, p(z) is not assumed to be a uniform distribution. This is in direct contrast with the conventional BayesSeg approach. As a result, the objective function in Equation 2 above is modified as shown below in Equation 3:

B(t)=max_{t′<t}(B(t′)b(t′+1, t))=max_{t′<t}(B(t′){p[x_{t′+1}, . . . xₜ}|z_{t′+1, . . .t}=j)p(z_{t′})) (3)

In one embodiment, to calculate p(z_{t′}), the feature function for the prior should first be calculated, as shown in Equations 4 (regarding cue words), 5 (regarding speaker change information), and 6 (regarding scene change information) below:

$$\begin{matrix}F ( {x}_{t} ) = \{ \begin{matrix}1 , & if sentence {x}_{t} starts with a cue word \\ 0 , & otherwise\end{matrix} & ( 4 ) \\ F ( {x}_{t} ) = \{ \begin{matrix}1 , & if sentence {x}_{t} is spoken by a different speaker \\ 0 , & otherwise\end{matrix} & ( 5 ) \\ F ( {x}_{t} ) = \{ \begin{matrix}1 , & if sentence {x}_{t} correpsonds to a scene change \\ 0 , & otherwise\end{matrix} & ( 6 )\end{matrix}$$

Based on the feature function, for each sentence, the segmentation prior is defined by Equation 7 below:

$$p ( {z}_{{t}^{′}} ) = \frac{f ( {x}_{{t}^{′}} )}{{\sum }_{{t}^{′} = 0}^{T} f ( {x}_{{t}^{′}} )} \qquad ( 7 )$$

In practice, to avoid zero values in p(z_{t′}), the feature functions shown above in Equation 4 could become

$$F ( {x}_{t} ) = \{ \begin{matrix}1 , & if sentence {x}_{t} starts with a cue word \\ 0 , & otherwise\end{matrix} \qquad ( 8 )$$

where c is a small value constant. Similarly, the feature functions shown above in Equations 5 and 6 could respectively become:

$$\begin{matrix}F ( {x}_{t} ) = \{ \begin{matrix}1 , & if sentence {x}_{t} is spoken by a different speaker \\ c , & otherwise\end{matrix} & ( 9 ) \\ F ( {x}_{t} ) = \{ \begin{matrix}1 , & if sentence {x}_{t} correpsonds to a scene change \\ c , & otherwise\end{matrix} & ( 10 )\end{matrix}$$

In Equation 3, the values of p(z_{t′}) can also originate from some early estimation result of other topic segmentation systems or human expert knowledge, not just limited by using feature functions defined as above. In other words, by setting the segmentation priors, an unsupervised framework can be provided for combining multiple potential boundary indicators to build an ensemble method.

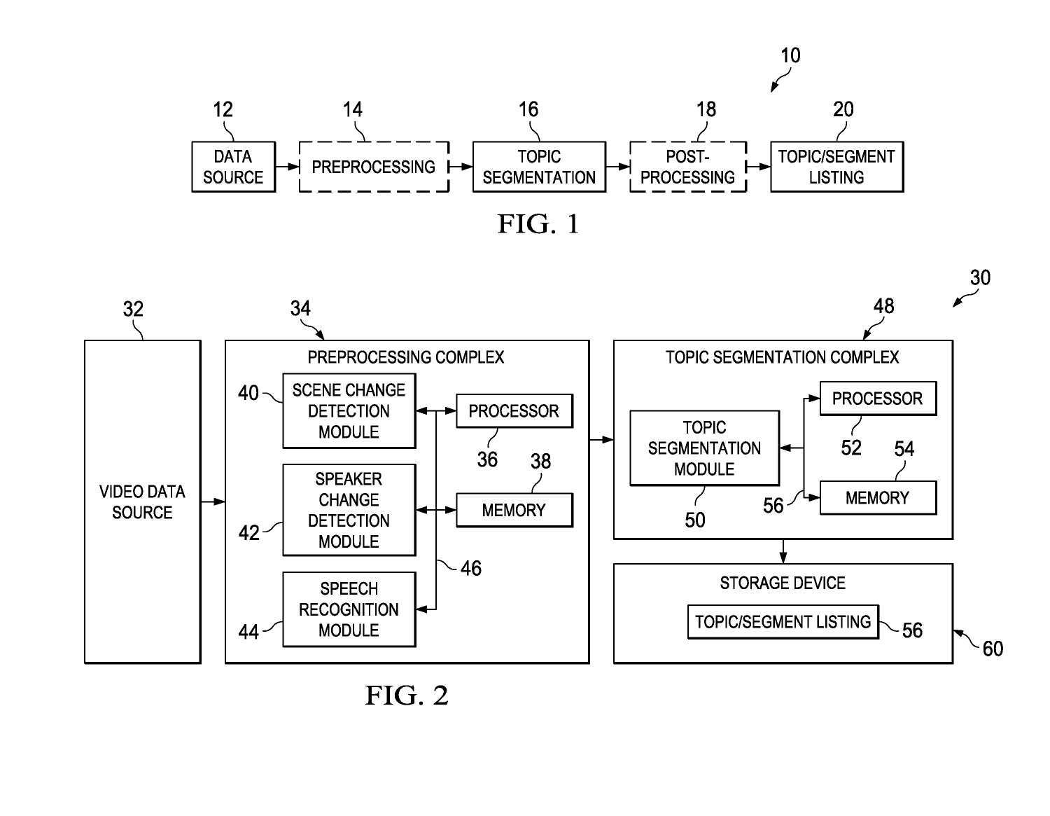

Turning now to FIG. 1, illustrated therein is a simplified block diagram of a system 10 for implementing an unsupervised topic segmentation method in a communications environment in accordance with one embodiment. In particular, system 10 implements a modified BayesSeg method that incorporates one or more potential boundary indicators for performing unsupervised topic segmentation in connection with video, audio, and/or text data in accordance with one embodiment. As shown in FIG. 1, system 10 includes a data source 12, an optional preprocessing element 14, a topic segmentation element 16, an optional post-processing element 18, and a topic/segment listing element 20. Data source 12 may include any available source of video data, audio data, text data, or combination thereof, including but not limited to a database, a data file, and/or a data stream. In one embodiment, the data source comprises a storage device, such as a hard drive, compact disc (“CD”), and/or digital video disc (“DVD”), for example, having stored thereon one or more files comprising video, audio and/or text data to be segmented by topic in accordance with the teachings set forth herein.

Data from data source 12 may be provided to the (optional) preprocessing element 14, where it may undergo any necessary or desirable preprocessing. For example, assuming the data is audio data, preprocessing may involve performing speech recognition on the data to create a transcript thereof. As another example, assuming the data is video data, in addition to performing speech recognition processing on the audio portion of the data, scene change detection and/or speaker change detection processing may also be performed thereon, with the scene and speaker changes detected being noted in connection with the data and transcript. The data and associated preprocessing information may then be provided to topic segmentation element 16, which performs unsupervised topic segmentation using additional potential boundary indicators (which may be derived from the preprocessing information) as will be described in detail below.

Data output from the topic segmentation element is input to optional post-processing element 18, where it may undergo any necessary or desirable post-processing. For example, one task that may be performed by the post-processing element is to remove a “segment” that is too short to be a topic. Another example of post-processing may be assigning a title to each segment based on key words in the segment. Once any necessary/desirable post-processing is performed, a topic/segment listing 20 is made available for use. For example, the topic/segment listing may be used to provide an index for the original source data, thereby rendering the data more easily searchable by a user.

FIG. 2 is a more detailed block diagram of a system 30 for implementing an unsupervised topic segmentation method in a communications environment in accordance with one embodiment. As shown in FIG. 2, system 30 is an example of a system for performing unsupervised topic segmentation on a data source comprising a video data source 32. In one embodiment, the video may be an enterprise video to be distributed to all employees within a company. It will be assumed for the sake of example that the video includes a variety of topics that may or may not be of particular interest to each employee; therefore, it would be useful for the video to be segmented by topic so that each employee could access only those particular segments that are relevant to him or her.

In the illustrated embodiment, the data signal comprising the data source 34 is input to a preprocessing complex 34, which comprises a processor 36, memory 38, scene change detection module 40, speaker change detection module 42, and speech recognition module 44, all of which may be interconnected, as represented by a bus 46. In accordance with features of one embodiment, the scene change detection module 40 processes the received data signal to determine the time stamp(s) at which the scene shown in the video changes. For example, a first scene of the video 30 may begin at a time t0. At a time t1, the scene changes and a second scene begins. Some period of time later, at a time t2, the scene once again changes and a third scene begins. The scene change detection module 40 detects each of the scene changes at times t1 and t2 and notes that information in connection with the data stream. In one embodiment, a scene change detection file containing all scene change information detected in connection with the video is developed by the module 40.

Similarly, in accordance with features of one embodiment, speaker change detection module 42 processes the received data signal comprising the video to determine the time stamp(s) at which a change in speaker occurs. For example, a first speaker may begin speaking at a time t0′. At a time t1′, a new speaker begins speaking. Some period of time later, at a time t2′, a third speaker begins speaking. Speaker change detection module 42 detects each of the speaker changes at times t1′ and t2′ and notes that information in connection with the data stream. In one embodiment, a speaker change detection file containing all speaker change information detected in connection with the video is developed by speaker change detection module 42.

The speech recognition module 44 also processes the data signal comprising the video and converts the audio portion of the signal to text using one of any number of known speech recognition algorithms and/or systems. In one embodiment, a file comprising a transcript of the text corresponding to the audio portion of the video is developed by the module 40.

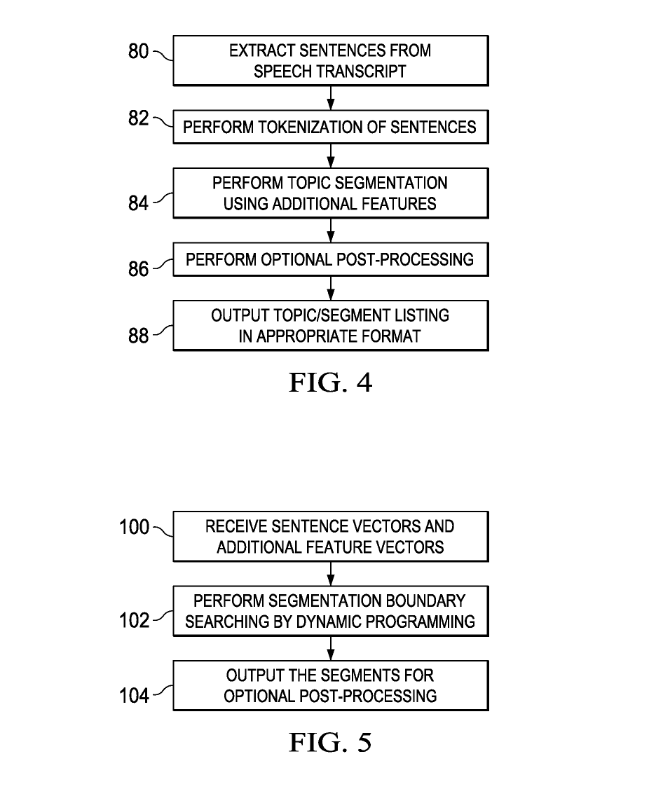

Once the data stream has been preprocessed at the complex 34, the data stream and corresponding scene change, speaker change, and speech recognition information (which as previously noted may be embodied in one or more files associated with the data stream) are input to a topic segmentation complex 48. As shown in FIG. 2, the topic segmentation complex may include a topic segmentation module 50, a processor 52, and a memory 54, all of which may be interconnected as represented by a bus 56. In accordance with features of the one embodiment, and as described in greater detail below with reference to FIG. 4, the topic segmentation module 50 may include software executable by the processor 52 in conjunction with the memory 54 for performing unsupervised topic segmentation in connection with the data stream comprising the video. In particular, the topic segmentation module 50 performs unsupervised topic segmentation using additional information comprising potential boundary indicators (such as scene change, speaker change, and cue words) to more accurately predict segment boundaries.

Once topic segmentation has been performed on the data by the topic segmentation module 50, post-processing may be performed. As noted above, post-processing may include any number of tasks necessary or desirable for improving the results of the topic segmentation. For example, one task that may be performed during post-processing is to remove a “segment” that is too short to be a topic. Another post-processing task may be assigning a title to each segment based on key words in the segment. Once post-processing (if necessary/desirable) has been performed, a topic/segment listing 58 may be provided. As illustrated in FIG. 2, the topic/segment listing 58 may be stored in a storage device 60. Additionally, the topic/segment listing 58 may be stored in association with and/or accessible by the video data source 32.

It will be noted that, although illustrated in one or more of FIGS. 1 and 2 as being implemented by separate and independent devices, one or more of preprocessing, topic segmentation, and post-processing functions may be implemented on the same device and utilize the same processor and/or memory elements.

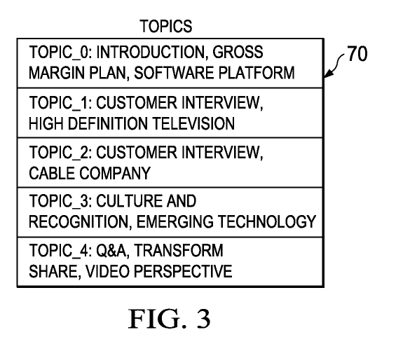

FIG. 3 illustrates an exemplary topic listing 70 that may be output from the systems illustrated and described herein. As shown FIG. 3, the listing 70 includes five topics. The first topic (“TOPIC_{—}0”) is designated “INTRODUCTION, GROSS MARGIN PLAN, SOFTWARE PLATFORM.” The second topic (“TOPIC_{—}1”) is designated “CUSTOMER INTERVIEW, HIGH DEFINITION TELEVISION.” The third topic (“TOPIC_{—}2”) is designated “CUSTOMER INTERVIEW, CABLE COMPANY.” The fourth topic (“TOPIC_{—}3”) is designated “CULTURE AND RECOGNAITON, EMERGINE TECHNOLOGY.” Finally, the fifth topic (“TOPIC_{—}4”) is designated “Q&A, TRANFORM SHARE, VIDEO PERSPECTIVE.” As previously noted, this topic listing 70, along with segment designations (not shown) may be employed by a user to more efficiently navigate the corresponding video, as bookmarks may be provided in the video by post-processing techniques to enable the user to skip directly to a segment of the video corresponding to a selected topic of interest to the user.

FIG. 4 is a flowchart illustrating a method for performing unsupervised topic segmentation in a communications environment in accordance with one embodiment. In 80, sentences are extracted from the transcript provided by the speech recognition module. Sentence extraction may be performed using one of any number of known methods; sentences are fairly easy to detect using common punctuation rules associated with the particular language model with which the data source is associated. In 82, each of the plurality of sentences is tokenized, as described in detail below. Tokenization is the process of breaking a stream of text up into words, phrases, symbols, or other meaningful elements called tokens. The list of tokens can become input for further processing such as parsing or text mining. Tokenization is useful both in linguistics (where it is a form of text segmentation), and in computer science, where it forms part of lexical analysis.

In particular, it will be assumed for the sake of example that the following sentences 1-4 (in which words are represented by letters A-G) are extracted from a transcript being processed:

| | |
|---|---|
| Sentence 1: | A B C D |
| Sentence 2: | E A F C G |
| Sentence 3: | B F C C G |
| Sentence 4: | E A C G B |

It will be further assumed that Sentence 1 is a sentence having no boundary indication information, Sentence 2 begins with a cue word (“E”), Sentence 3 corresponds to a speaker change event, and Sentence 4 begins with a cue word and corresponds to a speaker change event. After tokenization, each sentence may be represented by a sentence vector as indicated below:

| | Dictionary: | | | | | | |
|---|---|---|---|---|---|---|---|
| | A | B | C | D | E | F | G |
| Sentence 1: | 1 | 1 | 1 | 1 | 0 | 0 | 0 |
| Sentence 2: | 1 | 0 | 1 | 0 | 1 | 1 | 1 |
| Sentence 3: | 0 | 1 | 0 | 2 | 0 | 1 | 1 |
| Sentence 4: | 1 | 1 | 1 | 0 | 1 | 0 | 1 |

The cue word feature for each sentence may be represented as indicated below:

| | |
|---|---|
| Sentence 1: | 0 |
| Sentence 2: | 1 |
| Sentence 3: | 0 |
| Sentence 4: | 1 |

and the speaker change feature for each sentence may be represented as indicated below:

| | |
|---|---|
| Sentence 1: | 0 |
| Sentence 2: | 0 |
| Sentence 3: | 1 |
| Sentence 4: | 1 |

In 84, topic segmentation is performed using the tokenized sentences and applying the additional features. Topic segmentation in accordance with embodiments described herein will be described in greater detail below with reference to FIG. 5. In 86, optional post-processing, which may include removing a “segment” that is too short to be its own topic or assigning a title to the segment based on key words in the segment, may be performed. In 88, the topic/segment listing is output in an appropriate format. For example, the listing may be a physical list of topics to be employed by a user to navigate the corresponding video. Alternatively, the listing may be stored in a mass storage device. In yet another embodiment, the listing may be used to bookmark the video and then stored in association with the video as an index thereof.

FIG. 5 is a flowchart illustrating in greater detail an aspect of a method for performing unsupervised topic segmentation in a communications environment in accordance with one embodiment. In particular, FIG. 5 provides additional detail with regard to operations performed during the topic segmentation process (84) of FIG. 4. Referring to FIG. 5, in 100, sentence vectors and additional feature vectors for each sentence are identified as described in detail above.

In 102, segmentation boundary searching by dynamic programming is performed. In one embodiment, this may be performed in accordance with the pseudo-code set forth below:

```
DynamicProgramming(segII[ ][ ], T, K, cueVector[ ], speakerVector[ ]) {
    For i =1 to K do
        Initialize the segmentation C[ ][ ], B[ ][ ]
        For t = i to T do
            Initialize the value of best_score and best_index
            For t2 = 0 to t do
                Score = c[i−1][t2] +segII[t][t2]+
                log(cueVevtor[t2])+log(speakerVector[t2]+smallConst)
                If score>best_score then
                best_value = score
                best_idx = t2
            C[i][t] = best_value
            B[i][t] = best_idx
    Return B[ ][ ]
}
```

where segll[ ] [ ] is the segmentation log likelihood of each possible sentence groups, cueVector[ ] is the cue word feature vector of each possible sentence groups, speaker Vector[ ] is the speaker feature vector of each possible sentence groups, T is the number of sentences, K is the number of groups, C[ ] [ ] is the matrix for storing the best score (by summation of the segmentation log likelihood and additional feature score values, and B[ ] [ ] is the matrix for storing the corresponding indices of sentences with the best scores. In short, the pseudo code illustrates a dynamic programming search process that tries all of the possible segmentation possibilities and identifies the local optimal solution. Upon completion of 102, in 104, the topic/segment listing is output in an appropriate format.

It should be noted thatat much of the infrastructure discussed herein can be provisioned as part of any type of computer device. As used herein, the term “computer device” can encompass computers, servers, network appliances, hosts, routers, switches, gateways, bridges, virtual equipment, load-balancers, firewalls, processors, modules, or any other suitable device, component, element, or object operable to exchange information in a communications environment. Moreover, the computer devices may include any suitable hardware, software, components, modules, interfaces, or objects that facilitate the operations thereof. This may be inclusive of appropriate algorithms and communication protocols that allow for the effective exchange of data or information.

In one implementation, these devices can include software to achieve (or to foster) the activities discussed herein. This could include the implementation of instances of any of the components, engines, logic, modules, etc., shown in the FIGURES. Additionally, each of these devices can have an internal structure (e.g., a processor, a memory element, etc.) to facilitate some of the operations described herein. In other embodiments, the activities may be executed externally to these devices, or included in some other device to achieve the intended functionality. Alternatively, these devices may include software (or reciprocating software) that can coordinate with other elements in order to perform the activities described herein. In still other embodiments, one or several devices may include any suitable algorithms, hardware, software, components, modules, interfaces, or objects that facilitate the operations thereof.

Note that in certain example implementations, functions outlined herein may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory element, as may be inherent in several devices illustrated in the FIGURES, can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor, as may be inherent in several devices illustrated in FIGS. 1-4, including, for example, servers, fabric interconnects, and virtualized adapters, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory element (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory element.” Similarly, any of the potential processing elements, modules, and machines described in this Specification should be construed as being encompassed within the broad term “processor.” Each of the computer elements can also include suitable interfaces for receiving, transmitting, and/or otherwise communicating data or information in a communications environment.

Note that with the example provided above, as well as numerous other examples provided herein, interaction may be described in terms of two, three, or four computer elements. However, this has been done for purposes of clarity and example only. In certain cases, it may be easier to describe one or more of the functionalities of a given set of flows by only referencing a limited number of system elements. It should be appreciated that systems illustrated in the FIGURES (and their teachings) are readily scalable and can accommodate a large number of components, as well as more complicated/sophisticated arrangements and configurations. Accordingly, the examples provided should not limit the scope or inhibit the broad teachings of illustrated systems as potentially applied to a myriad of other architectures.

It is also important to note that the steps in the preceding flow diagrams illustrate only some of the possible signaling scenarios and patterns that may be executed by, or within, the illustrated systems. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the illustrated systems in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
extracting a plurality of sentences from data, which comprises a speech transcript;
tokenizing the plurality of sentences to develop for each of the plurality of sentences a sentence vector and at least one feature vector; and
performing topic segmentation on the speech transcript using the sentence vectors and feature vectors, wherein the topic segmentation is to result in a listing of segments corresponding to the speech transcript.

2. The method of claim 1 further comprising preprocessing source data generated by a data source to develop the speech transcript.

3. The method of claim 2, wherein the source data comprises audio data.

4. The method of claim 2, wherein the source data comprises video data.

5. The method of claim 2, wherein the listing of segments comprises an index to the source data.

6. The method of claim 1, further comprising:
performing post-processing on the listing of segments to remove items that do not meet minimum requirements for segments.

7. The method of claim 1, further comprising:
performing post-processing on the listing of segments to assign a title to each segment in the listing based on key words.

8. The method of claim 1, wherein the at least one feature vector comprises at least one of a cue word feature vector, a speaker change feature vector, and a scene change feature vector.

9. The method of claim 1, wherein the performing topic segmentation comprises performing segmentation boundary searching by dynamic programming.

10. One or more non-transitory tangible media that includes code for execution and when executed by a processor is operable to perform operations comprising:
extracting sentences from data, which comprises a speech transcript;
tokenizing the plurality of sentences to develop for each of the plurality of sentences a sentence vector and at least one feature vector; and
performing topic segmentation on the speech transcript using the sentence vectors and feature vectors, wherein the topic segmentation is to result in a listing of segments corresponding to the speech transcript.

11. The media of claim 10, wherein the operations further comprise preprocessing source data generated by a data source to develop the speech transcript.

12. The media of claim 11, wherein the listing of segments comprises an index to the source data.

13. The media of claim 10, wherein the operations further comprise performing post-processing on the listing of segments, the post-processing comprising removing items that do not meet minimum requirements for segments.

14. The media of claim 10, wherein the at least one feature vector comprises at least one of a cue word feature vector, a speaker change feature vector, and a scene change feature vector.

15. The media of claim 10, wherein the performing topic segmentation comprises performing segmentation boundary searching by dynamic programming.

16. An apparatus comprising:
a memory element configured to store data;
a processor operable to execute instructions associated with the data; and
a topic segmentation module, wherein the apparatus is configured to:
extract sentences from data, which comprises a speech transcript developed from source data;
tokenize the plurality of sentences to develop for each of the plurality of sentences a sentence vector and at least one feature vector; and
perform topic segmentation on the speech transcript using the sentence vectors and feature vectors, wherein the topic segmentation is to result in a listing of segments corresponding to the speech transcript.

17. The apparatus of claim 16, wherein the listing of segments comprises an index to the source data.

18. The apparatus of claim 16, further comprising:
a post-processing module configured to remove items that do not meet minimum requirements for segments, and to remove a title to each segment in the listing based on key words.

19. The apparatus of claim 16, wherein the at least one feature vector comprises at least one of a cue word feature vector, a speaker change feature vector, and a scene change feature vector.

20. The apparatus of claim 16, wherein the performing topic segmentation comprises performing segmentation boundary searching by dynamic programming.
